(19) United States
(12) Patent Application Publication
(10) Pub. No.: US 2018/0330389 A1
(43) Pub. Date: Nov. 15, 2018

(54) METHODS AND SYSTEMS FOR IDENTIFYING POINTS OF USER INTEREST BASED ON IMAGE PROCESSING

(71) Applicant: salesforce.com, inc., San Francisco, CA (US)

(72) Inventors: Alan Hwang, San Francisco, CA (US); Youngjun Kwak, San Francisco, CA (US)

(73) Assignee: salesforce.com, inc., San Francisco, CA (US)

(21) Appl. No.: 15/595,041

(22) Filed: May 15, 2017

(51) Int. Cl. G06Q 30/02; G06F 17/30; G06Q 50/00; H04L 29/08; G06K 9/62; G06N 3/02

(52) U.S. Cl. CPC G06Q 30/0202; G06F 17/30256; G06N 3/02; H04L 67/22; G06K 9/6267; G06Q 50/01

(57) ABSTRACT

A method for identifying positive online usage trends based on image analysis has been developed. First, a target group is identified as a subject of analysis and online image postings by that group are captured and analyzed for subject matter and favorable usage using convolution neural networking. Data associated with the subject matter and favorable usage are stored as a dataset related to the target group in a database. Parameters are selected that indicate a positive usage trend and a predictive model analyzes the stored data sets based on those parameters.

### TECHNICAL FIELD

Embodiments of the subject matter described herein relate generally to image processing. More particularly, embodiments of the subject matter relate to identifying points of user interest based on image processing.

### BACKGROUND

Posting of online images proliferate modern Internet usage. Examples of images posted include not only pictures of individuals such as “selfies”, the pictures of items, locations and activities that are of interest to the poster. The posting of images may be a significant indicator of user interest across various groupings including demographics, regions and areas of identified common interest.

At the same time, modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram of an exemplary multi-tenant computing environment;

FIG. 2 is a flowchart depicting an example of one embodiment of the method of identifying positive usage trends based on online images; and

FIG. 3 is a dataflow diagram depicting an example of one embodiment of the method of identifying positive usage trends based on online images.

### DETAILED DESCRIPTION

It would be advantageous to analyze the images posted across a data group to identify points of interest and detect positive usage trends across groups. Embodiments of the subject matter described herein generally relate to techniques for processing and analysis of posted online images. More particularly, embodiments of the subject matter relate to identifying positive usage trends based on analysis of posted online images. The disclosed embodiments described below may be implemented in a wide variety of different computer-based systems, architectures and platforms which may include a multi-tenant system. Additionally, the disclosed embodiments may be implemented using mobile devices, smart wearable devices, virtual systems, etc.

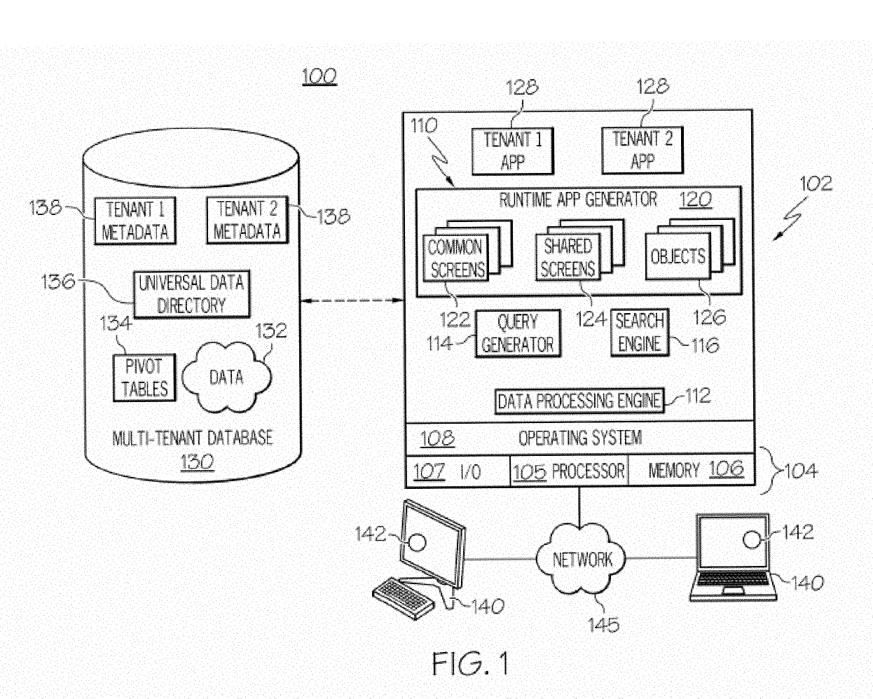

Turning now to FIG. 1, an exemplary multi-tenant system 100 includes a server 102 that dynamically creates and supports virtual applications 128 based upon data 132 from a database 130 that may be shared between multiple tenants, referred to herein as a multi-tenant database. Data and services generated by the virtual applications 128 are provided via a network 145 to any number of client devices 140, as desired. Each virtual application 128 is suitably generated at run-time (or on-demand) using a common application platform 110 that securely provides access to the data 132 in the database 130 for each of the various tenants subscribing to the multi-tenant system 100. In accordance with one non-limiting example, the multi-tenant system 100 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 130. In this regard, each tenant includes one or more users associated with, assigned to, or otherwise belonging to that respective tenant. Stated another way, each respective user within the multi-tenant system 100 is associated with, assigned to, or otherwise belongs to a particular one of the plurality of tenants supported by the multi-tenant system 100. Tenants may represent companies, corporate departments, business or legal organizations, and/or any other entities that maintain data for particular sets of users (such as their respective customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other tenants.

The multi-tenant database 130 may be a repository or other data storage system capable of storing and managing the data 132 associated with any number of tenants. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein. In an exemplary embodiment, the database 130 includes a database management system or other equivalent software capable of determining an optimal query plan for retrieving and providing a particular subset of the data 132 to an instance of virtual application 128 in response to a query initiated or otherwise provided by a virtual application 128, as described in greater detail below. The multi-tenant database 130 may alternatively be referred to herein as an on-demand database, in that the multi-tenant database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like. The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below. Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. As noted above, the virtual application 128 may contain Java, ActiveX, or other content that can be presented using conventional client software running on the client device 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128.

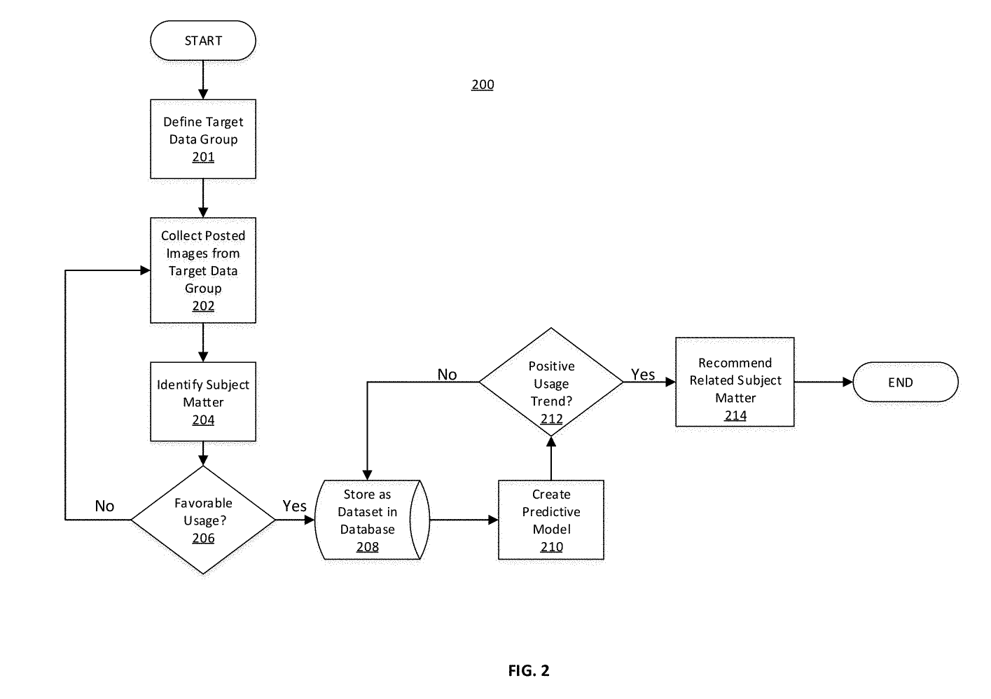

In accordance with one embodiment, application 128 may embody techniques for identifying positive online usage trends based on image analysis. Turning now to FIG. 2, a flowchart 200 is shown that illustrates one embodiment of the present method. The first step involves defining a “target data group” for analysis 201. A target data group may be selected on the basis of demographic characteristics such as age, gender, income or education. Additionally, a target data group may be a single individual. In alternative embodiments, the target data group may be selected on the basis of a geographical region. Examples of this may include urban, suburban or rural locales. It may also be regions of countries or even continents. Regions may also be selected on the basis of geography such as beaches, mountains, etc. Still in other embodiments, a target data group may be selected on the basis of a common identified interest among its members. Examples of this may include specific professions, hobbies or other personal interests.

Once the target data group is defined, images that are posted online from the target data group are collected 202. The images that are posted online may come from a wide variety of online platforms and sources. These include social media sites such as Facebook, Pinterest, Twitter, Instagram, and other similar sites that allow users to post, view or download images or videos. Additionally, images may be collected from commercial sites such as Amazon, eBay, Zillow, and other similar sites that allow users to select commercial products of interest. Also, images may be collected from any other platforms that allow users to either select, view, download, post or otherwise express interest in images including Internet linked devices such as smartphones, appliances, cars, portable devices, etc. The collected images may be of any suitable format and may be from various different sources including still images, videos, graphical images including animation, etc. The target data group is defined by the user of the system who desires to detect a positive usage trend. In one embodiment, the user may access the system as part of a multi-tenant database system shown previously in FIG. 1. The multi-tenant database system could be made commercially available to the user for such things as marketing research, sales promotion, customer identification, etc. The user would be able to access the system and its database to adjust the parameters of the target data group based on the user's needs.

After the images are collected, the subject matter of the images is identified 204. In one embodiment, the subject matter of the image is identified using convolution neural networking (“CNN” or “ConvNet”). CNN is a type of machine learning feed-forward artificial neural network in which the connectivity pattern is inspired by the organization of a biological visual cortex. The convolutional neural networks are multiple layers of receptive fields. These are small collections which process portions of the input image. The outputs of these collections are then tiled so that their input regions overlap, to obtain a higher-resolution representation of the original image. This tiling is repeated for every such layer. The layers of a CNN are arranged in three dimensions: width, height and depth. The inside of a layer is only connected to a small region of the layer before it, called a receptive field. Distinct types of layers, both locally and completely connected, are stacked to form a CNN architecture. Subject matter detection using CNN is rugged despite any distortions resulting from change in shape due to camera lens, different lighting conditions, different poses, presence of partial occlusions, horizontal and vertical shifts, etc. Once the CNN architecture is formed, a search is performed on a pre-loaded database of identified images to find related subject matter based on features and or text. If the found subject matter matches the characteristics in the CNN architecture, the image is identified and its data is stored as part of a dataset in the system's database for later retrieval and analysis.

Once the subject matter of the image is identified, it must be determined whether the usage among the target data group is in a favorable context 206. Favorable usage may be determined by the overall context of the posting of the image. For example, an image posted to Pinterest may indicate a favorable usage of the subject matter. Additionally, favorable usage may be indicated by the presence of “likes” submitted by other viewers of the image (e.g., Likes on a Facebook page). Non-favorable usage of the image will be discarded and not saved. Also, the context of favorable usage will also be reviewed to ensure the usage is appropriate. For example, favorable usage that is part of satire or parody will be excluded. Such usage would be detected during the image identification processing described earlier (e.g., the system finds related subject matter to the image that is part of an Internet meme).

Data regarding a favorable usage of an image within a target data group will then be stored as part of the dataset for that particular target data group in a database 208. The data may include information about identifying characteristics of the subject matter. For example, if the subject matter of the image was a home listed on a real estate website, such things as the architectural style and other physical characteristics of the image would be stored. Also, the date, time and number of times an image was accessed or posted by the target data group. For example, in the case of a real estate search, the number of times that an image with a particular architectural style was viewed would be stored. Also, the number of times any real estate image was viewed would be stored as well.

The database will store datasets for each defined target data group in a computer readable media. Additionally, individual characteristics of identified subject matter may be stored as subsets of a particular dataset. The datasets may be retrieved from the database for analysis of the images. Also, the contents of the datasets may be adjusted based upon redefining a target data group or selecting different analysis parameters.

A predictive model is created to analyze a dataset 210 by a user of the system. Parameters are selected by the user to determine if a “positive usage trend” is present 212. The user is offered great flexibility to select and adjust the parameters of the predictive model. The parameters may be straightforward and simple such as “greater than 50% favorable usage of all images viewed by the target data group” indicates a positive usage trend. In other embodiments, the parameters may be set to include consideration of a specific period of time. For example, “greater than 50% favorable usage of all images viewed over the past 2 months by the target data group” indicates a positive usage trend. In other examples, the parameters may be set to look for a specified rate of increase over a period of time such as “a 25% increase in favorable usage of all images viewed over the past 2 months by the target data group”. If no positive usage trend is found, this result may be stored in the database for future reference in relation to the dataset. The predictive model may be instructed by the user to automatically resample and reanalyze a dataset either periodically or continuously to detect a positive usage trend on an ongoing basis.

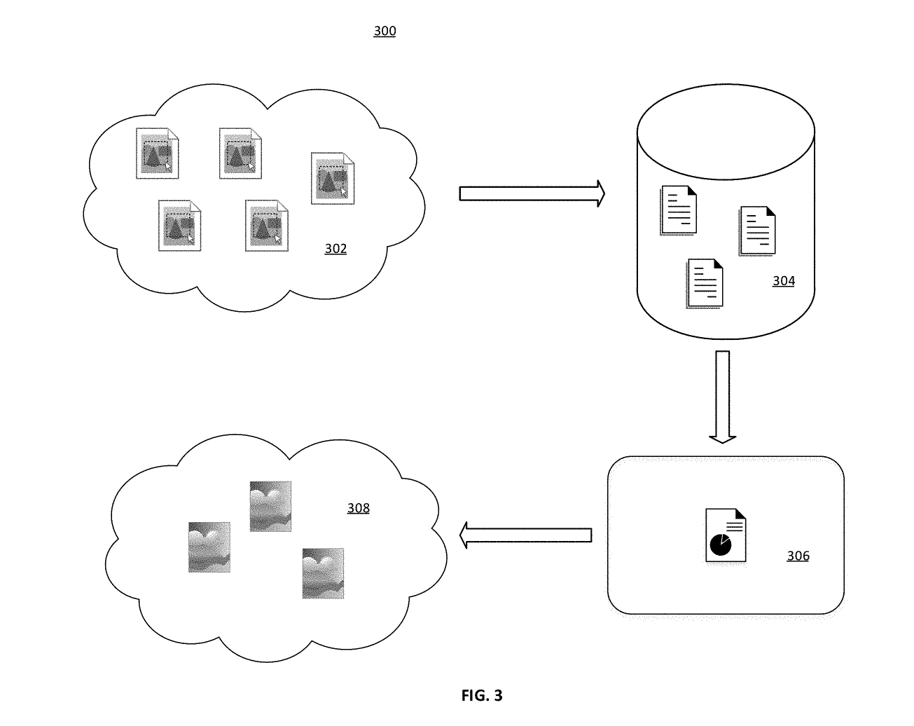

If a positive usage trend is found for specific subject matter within a target data group, related subject matter is identified and recommended to members of the target data group. These recommendations may be commercial products for sale, items or activities of similar interest, etc. Turning now to FIG. 3, a dataflow diagram 300 is shown that represents an example of one embodiment of this method. In this example, images are collected from a real estate search website 302. In this example, the images are part of a real estate search website. The owner of the real estate search website is the user of the system and the target data group is an individual customer using the website. The images viewed by the individual customer are collected and analyzed for different real estate characteristics such as location, features and architectural style. Each of these characteristics is stored in a different dataset for this individual customer 304. A predictive model has been created 306 by the owner of the real estate website to look for a positive usage trend if favorable usage is detected in greater than 50% of the images viewed by the individual customer contain a specific characteristic. In this example, the individual customer clicked on images of homes with Victorian-style architecture more than 50% of the time. Consequently, the owner of the real estate search website is notified of the positive usage trend for the individual customer and recommends other listings with Victorian-style architecture 308.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

“Node/Port”—As used herein, a “node” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common node). As used herein, a “port” means a node that is externally accessible via, for example, a physical connector, an input or output pin, a test probe, a bonding pad, or the like.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed in connection with process for identifying positive online usage trends based on image analysis may be performed by software, hardware, firmware, or any combination thereof. For illustrative purposes, the preceding description of process for identifying positive online usage trends based on image analysis may refer to elements mentioned above in connection with FIGS. 2 and 3. In practice, portions of process for identifying positive online usage trends based on image analysis may be performed by different elements of the described system, e.g., component A, component B, or component C. It should be appreciated that process for identifying positive online usage trends based on image analysis may include any number of additional or alternative tasks, the tasks shown in FIG. 2 need not be performed in the illustrated order, and process for identifying positive online usage trends based on image analysis may be incorporated into a more comprehensive procedure or process having additional functionality not described in detail herein. Moreover, one or more of the tasks shown in FIG. 2 could be omitted from an embodiment of the process for identifying positive online usage trends based on image analysis as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for identifying positive online usage trends based on image analysis, comprising:
defining a target data group as subject of positive usage analysis that reflects a positive usage trend of an identified subject matter by the target data group;
capturing online image postings from the target data group from across online media platforms;
analyzing the captured online images to obtain subject matter identification data and favorable usage indication data using convolution neural networking;
storing subject matter identification data and favorable usage indication data as a dataset for the target data group in a database;
establishing analysis parameters that will indicate a positive usage trend for the identified subject matter by the target data group;
creating a predictive model that detects the positive usage trend using the analysis parameters; and
activating a notification of the positive usage trend for the identified subject matter within target data group.

2. The method of claim 1, further comprising:
filtering out non-positive usage of the identified subject matter with the predictive model.

3. The method of claim 1, further comprising:
recommending related subject matter to the target data group based on the positive usage trend.

4. The method of claim 1, where the analysis parameters that indicate a positive usage trend comprise a greater than 50% favorable usage of all captured online image postings from the target data group that contain the identified subject matter.

5. A database system comprising a processor in communication with a memory element that has computer-executable instructions stored thereon and configurable to be executed by the processor to cause the database system to:
define a target data group as subject of positive usage analysis that reflects a positive usage trend of an identified subject matter by the target data group;
capture online image postings from the target data group from across online media platforms;
analyze the captured online images to obtain subject matter identification data and favorable usage indication data using convolution neural networking;
store subject matter identification data and favorable usage indication data as a dataset for the target data group in the database system;
establish analysis parameters that will indicate a positive usage trend for the identified subject matter by the target data group;
create a predictive model that detects the positive usage trend using the analysis parameters; and
activate a notification of the positive usage trend for the identified subject matter within target data group.

6. The system of claim 5, where the online media platforms comprise social media platforms.

7. The system of claim 5, where the online media platforms comprise internet connected mobile devices.

8. The system of claim 5, where the online media platforms comprise internet connected wearable devices.

9. The system of claim 5, where the online media platforms comprise internet connected virtual reality systems.

10. The system of claim 5, where the data base system comprises a multi-tenant database system.

11. A computer readable media having computer-executable instructions stored thereon and configurable to be executed by a processor to perform a method comprising:
defining a target data group as subject of positive usage analysis that reflects a positive usage trend of an identified subject matter by the target data group;
capturing online image postings from the target data group from across online media platforms;
analyzing the captured online images to obtain subject matter identification data and favorable usage indication data using convolution neural networking;
storing subject matter identification data and favorable usage indication data as a dataset for the target data group in a database;
establishing analysis parameters that will indicate a positive usage trend for the identified subject matter by the target data group;
creating a predictive model that detects the positive usage trend using the analysis parameters; and
activating a notification of the positive usage trend for the identified subject matter within target data group.

12. The computer readable media of claim 11, where the dataset for the target data group is updated on a predetermined time period.

13. The computer readable media of claim 11, where the dataset for the target data group is updated on a continuous basis.

14. The computer readable media of claim 11, where the captured online image postings comprise images viewed by the target data group.

15. The computer readable media of claim 11, where the captured online image postings comprise images downloaded by the target data group.

16. The computer readable media of claim 11, where the captured online image postings comprise video images viewed by the target data group.

17. The computer readable media of claim 11, where the captured online image postings comprise video images downloaded by the target data group.
